(19) United States
(12) Patent Application Publication
(10) Pub. No.: US 2017/0341896 A1
(43) Pub. Date: Nov. 30, 2017

(54) MEDIUM HANDOVER DEVICE AND SHUTTER OPENING-AND-CLOSING MECHANISM

(71) Applicant: Oki Electric Industry Co., Ltd., Tokyo (JP)

(72) Inventors: Akira GOTOU, Tokyo (JP); Kenji KADOTA, Tokyo (JP)

(73) Assignee: Oki Electric Industry Co., Ltd., Tokyo (JP)

(21) Appl. No.: 15/536,989

(22) PCT Filed: Oct. 19, 2015
(86) PCT No.: PCT/JP2015/079461

§ 371 Date: Jun. 16, 2017

(30) Foreign Application Priority Data
Jan. 19, 2015 (JP) 2015-007869

(51) Int. Cl. B65H 29/46; G07D 11/00; G07D 9/04

(52) U.S. Cl. CPC B65H 29/46; G07D 11/0087; G07D 11/0054; G07D 9/04

(57) ABSTRACT

A banknote pay-out device includes a pay-out port where a banknote bundle is handed over to a user, a shutter that is provided so as to capable of closing or opening the pay-out port, a gripping conveyance guide and a stage that guide the banknote bundle W, and a push-out plate that is disposed facing the gripping conveyance guide and the stage, and that moves in a handover direction toward the pay-out port while contacting one edge side of the banknote bundle to convey the banknote bundle toward the pay-out port. The banknote pay-out device also includes a shutter opening-and-closing projection that, as the push-out plate moves toward the pay-out port, moves together with the push-out plate and moves the shutter toward an opening direction to open the pay-out port.

### TECHNICAL FIELD

The present invention relates to a medium handover device and a shutter opening-and-closing mechanism, and is, for example, well-suited to application to a banknote pay-out device that pays out banknotes as a medium.

### BACKGROUND ART

Hitherto, banknote pay-out devices are widely employed, for example, in financial institutions, to pay out cash such as banknotes and coins in response to a request from a user.

A proposal for such a banknote pay-out device includes, for example, banknote storage boxes that store banknotes, a conveyance section that conveys banknotes, a classification section that classifies banknotes, a stacking section that stacks banknotes that can be paid out, a reject storage box that stores reject banknotes that are unsuitable for pay-out, a bundle conveyance section that conveys a bundle of stacked banknotes, and a pay-out port that hands over banknotes to a user (see, for example, Japanese Patent No. 5156097 (FIG. 1)).

### SUMMARY OF INVENTION

### Technical Problem

In some such banknote pay-out devices, a shutter is provided to the pay-out port, and a dedicated actuator is provided to open and close the shutter, and it is desirable to simplify the configuration thereof.

In consideration of the above circumstances, the present invention proposes a medium handover device and shutter opening-and-closing mechanism capable of simplifying configuration.

### Solution to Problem

To address this issue, the medium handover device of the present invention includes a handover port that hands over a medium bundle of a superimposed, paper sheet shaped medium to a user, a shutter that is provided so as to be capable of closing or opening the handover port, and a conveyance guide that guides the medium bundle. The medium handover device also includes a conveyance member that is disposed facing the conveyance guide, and that moves in a handover direction toward the handover port while contacting one edge side of the medium bundle to convey the medium bundle toward the handover port. The medium handover device also includes a shutter opening member that, as the conveyance member moves toward the handover port, moves together with the conveyance member so as to move the shutter toward an opening direction opening the handover port.

The shutter opening-and-closing mechanism of the present invention includes the conveyance member that moves in the handover direction toward the handover port for handing over the superimposed, paper sheet shaped medium to a user while contacting the one edge side of the medium bundle to convey the medium bundle toward the handover port, and the shutter opening member. As the conveyance member moves toward the handover port, the shutter opening member moves together with the conveyance member so as to move the shutter, provided so as to be capable of closing or opening the handover port, toward the opening direction opening the handover port.

The present invention is capable of opening and closing the shutter utilizing drive force of a drive source for driving the conveyance member, without providing a drive source to open and close the shutter separately to a drive source to drive the conveyance member.

### Advantageous Effects of Invention

The present invention is capable of realizing a medium handover and a shutter opening-and-closing mechanism capable of achieving simpler configuration.

### BRIEF DESCRIPTION OF DRAWINGS

FIG. 1 is a side view from the left illustrating configuration of a banknote pay-out device.

FIG. 2 is a side view from the left illustrating configuration of a banknote pay-out device in a state in which a bundle conveyance unit has been detached from a storage unit.

FIG. 3A is a front view illustrating configuration of a bundle conveyance unit.

FIG. 3B is a cross-section as viewed along arrows A-A in FIG. 3A.

FIG. 3C is a cross-section as viewed along arrows B-B in FIG. 3A.

FIG. 4A is a side view from the left illustrating configuration of a shutter opening-and-closing mechanism according to a first exemplary embodiment.

FIG. 4B is a side view from the left illustrating configuration of a shutter opening-and-closing mechanism according to the first exemplary embodiment.

FIG. 4C is a side view from the left illustrating configuration of a shutter opening-and-closing mechanism according to the first exemplary embodiment.

FIG. 4D is a side view from the left illustrating configuration of a shutter opening-and-closing mechanism according to the first exemplary embodiment.

FIG. 5A is a schematic diagram illustrating a pay-out operation.

FIG. 5B is a schematic diagram illustrating a pay-out operation.

FIG. 5C is a schematic diagram illustrating a pay-out operation.

FIG. 6A is a schematic diagram illustrating a take-in operation.

FIG. 6B is a schematic diagram illustrating a take-in operation.

FIG. 7A is a side view from the left illustrating configuration of a shutter opening-and-closing mechanism according to a second exemplary embodiment.

FIG. 7B is a side view from the left illustrating configuration of a shutter opening-and-closing mechanism according to the second exemplary embodiment.

FIG. 7C is a side view from the left illustrating configuration of a shutter opening-and-closing mechanism according to the second exemplary embodiment.

FIG. 7D is a side view from the left illustrating configuration of a shutter opening-and-closing mechanism according to the second exemplary embodiment.

FIG. 8A is a side view from the left illustrating configuration of a shutter opening-and-closing mechanism according to a third exemplary embodiment.

FIG. 8B is a side view from the left illustrating configuration of a shutter opening-and-closing mechanism according to the third exemplary embodiment.

FIG. 8C is a side view from the left illustrating configuration of a shutter opening-and-closing mechanism according to the third exemplary embodiment.

FIG. 8D is a side view from the left illustrating configuration of a shutter opening-and-closing mechanism according to the third exemplary embodiment.

### DESCRIPTION OF EMBODIMENTS

Explanation follows regarding embodiments of the invention (referred to below as exemplary embodiments), with reference to the drawings.

### 1. First Exemplary Embodiment

1-1. Configuration of Banknote Pay-out Device

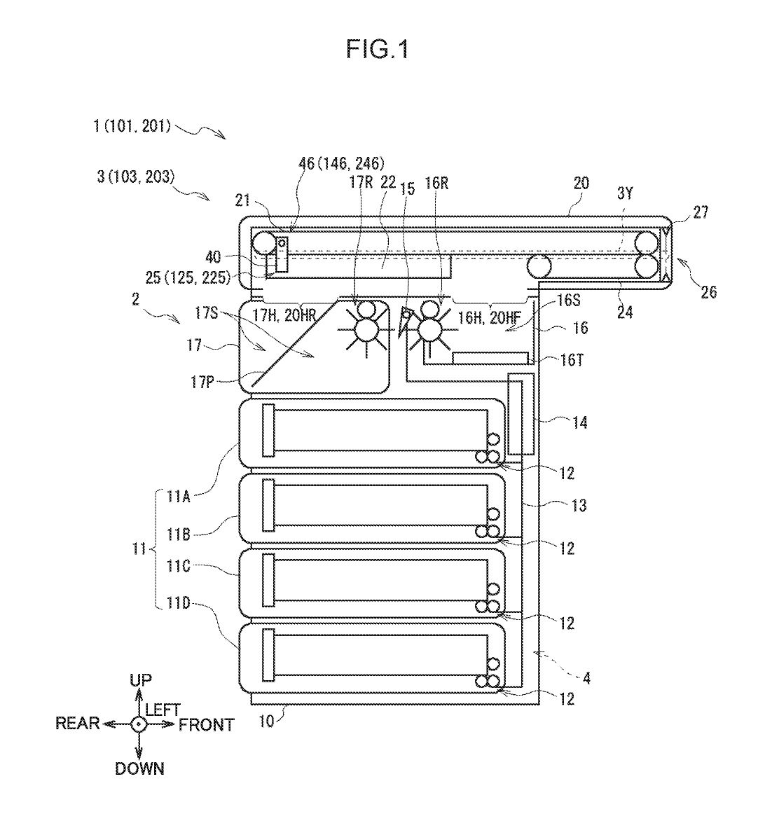

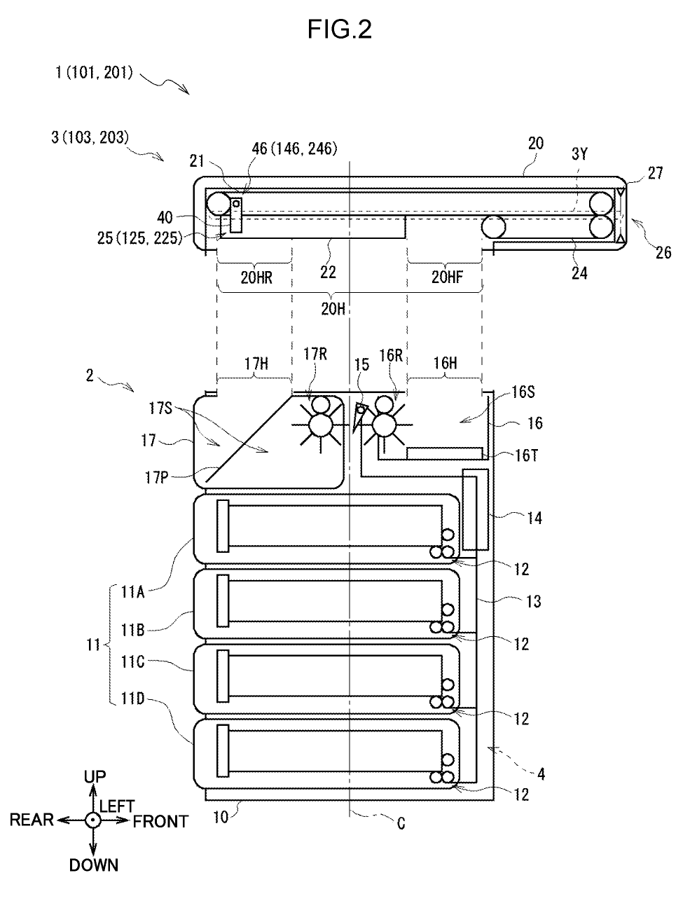

As illustrated in FIG. 1 and FIG. 2, a banknote pay-out device 1 according to the first exemplary embodiment is installed in a financial institution or the like and pays out banknotes based on operation by a user (namely, a customer of the financial institution). The banknote pay-out device 1 is configured broadly split into a storage unit 2 on a lower side and a bundle conveyance unit 3 on an upper side and is incorporated with a controller 4 that controls the overall banknote pay-out device 1. During manufacture, the banknote pay-out device 1 is assembled by attaching the bundle conveyance unit 3 on the upper side to the storage unit 2 on the lower side. For ease of explanation, FIG. 2 illustrates configuration of the banknote pay-out device 1 in a state in which the bundle conveyance unit 3 has been detached from the storage unit 2.

The controller 4 is configured around a Central Processing Unit (CPU), not illustrated in the drawings, and performs processing such as pay-out processing by reading and executing a predetermined program from Read Only Memory (ROM), flash memory, or the like, not illustrated in the drawings. The controller 4 also includes an internal storage section configured by Random Access Memory (RAM), a hard disk drive, flash memory, or the like, and stores various information in the storage section.

In the following explanation, the front side is defined as the side of the banknote pay-out device 1 that a customer faces, and the back side is defined as the opposite side thereto. The left side and the right side are defined as the left and the right as seen by a customer facing the front side, and the upper side and the lower side are also defined from the perspective of a customer facing the front side.

1-2. Configuration of Storage Unit

In the storage unit 2, plural sections that perform various processing relating to banknotes are incorporated inside a rectangular block shaped storage casing 10. The storage unit 2 stores banknotes and stacks banknotes so as to generate loose bundles of banknotes to be handed over to a user. Four banknote storage boxes 11 (11A, 11B, 11C, and 11D), a conveyance section 13, a classification section 14, a switching section 15, a stacking section 16, and a reject storage box 17 are provided inside the storage casing 10.

The banknote storage boxes 11 (11A, 11B, 11C, and 11D) serving as medium storage boxes are attached at a rear side of the storage casing 10 so as to be superimposed on each other, spanning from the up-down direction center to the lower side of the storage casing 10. Each banknote storage box 11 is formed in a flattened rectangular block shape that is short in the up-down direction and that is long in the front-rear direction. Each banknote storage box 11 internally stores banknotes in a state with their faces facing in the front-rear direction and in a row along the front-rear direction. Moreover, a feed-out section 12 that separates and feeds out stored banknotes one note at a time is provided at a front side lower portion of each banknote storage box 11.

Each banknote storage box 11 is detached from the storage casing 10 by pulling out the banknote storage box 11 toward the rear with respect to the storage casing 10. The banknote storage box 11 can be mounted to the storage casing 10 by being positioned with respect to the storage casing 10 and pushing the banknote storage box 11 in toward the front. Namely, each banknote storage box 11 is configured so as to be detachable from a rear face of the storage casing 10. Moreover, each banknote storage box 11 stores banknotes of a preset denomination.

The conveyance section 13 configures a conveyance path, this being a path along which banknotes are conveyed, and being configured from rollers, belts, and a motor or the like that drives them, not illustrated in the drawings. As shown by solid lines in the drawings, the conveyance path is connected to the feed-out section 12 of each banknote storage box 11, and progresses along the up-down direction at the front side of the respective banknote storage boxes 11 until it reaches the vicinity of the front-rear direction center at the upper side of the banknote storage box 11A at the uppermost position. The conveyance section 13 moves banknotes fed out from the feed-out section 12 of each banknote storage box 11 substantially upward in a direction of travel aligned with the short edges of the banknotes.

The classification section 14 is provided along the conveyance path of the conveyance section 13 at a portion of the conveyance section 13 that is at the front side of the banknote storage box 11A. Plural sensors of various types, such as a thickness sensor and an image sensor, are incorporated inside the classification section 14. The classification section 14 classifies the denomination, travel state, and the like of conveyed banknotes based on information obtained from the respective sensors, and supplies the classification results to the controller 4. The controller 4 determines the conveyance destination of each banknote based on the acquired classification results. Specifically, the controller 4 determines the stacking section 16 to be the conveyance destination for normal banknotes that are suitable for pay-out, and determines the reject storage box 17 to be the conveyance destination for banknotes not suitable to be paid out (referred to below as reject banknotes).

The switching section 15 is disposed substantially at the front-rear direction center at the upper side of the banknote storage box 11A. Under the control of the controller 4, the switching section 15 switches the banknote direction of travel by changing an angle of inclination of a blade (illustrated in a triangular shape in the drawings) that abuts banknotes so as to change their direction of travel. The switching section 15 is connected through the conveyance section 13 to the classification section 14 at the lower side, the stacking section 16 at the front side, and the reject storage box 17 at the rear side respectively. The switching section 15 switches the direction of travel of respective banknotes conveyed from below according to the conveyance destination determined by the controller 4, and moves the banknotes to the stacking section 16 at the front side or the reject storage box 17 at the rear side.

The stacking section 16 is positioned at the front side of an uppermost side inside the storage casing 10. A stacking space 16S, this being a space in which banknotes are stacked, is formed inside the stacking section 16. The stacking section 16 includes a stage 16T, on an upper face of which banknotes are stacked, inside the stacking space 16S. The stage 16T is formed in a thin plate shape that is thin in the up-down direction. The front-rear direction and left-right direction lengths of the stage 16T are longer than the respective short edges and long edges of the banknotes.

A discharge section 16R for discharging banknotes conveyed from the switching section 15 into the stacking space 16S is provided toward the top of the rear side of the stacking section 16. Banknotes conveyed from the switching section 15 and discharged into the stacking space 16S by the discharge section 16R are stacked upon the stage 16T of the stacking section 16. Banknotes stacked upon the stage 16T when this is performed are superimposed on each other in the form of a loose bundle. Banknotes superimposed in this manner are accordingly also referred to below as banknote bundles.

Moreover, the stage 16T is moved in an up-down direction by a stage moving mechanism, not illustrated in the drawings. An upper face of the stacking section 16 is provided with a stacking hole 16H penetrating in the up-down direction over a range corresponding to the stacking space 16S. The front-rear direction length of the stacking hole 16H is slightly longer than the front-rear direction length of the stage 16T. The stacking hole 16H also penetrates an upper face of the storage casing 10, and places the stacking space 16S in communication with a space further toward the upper side than the storage casing 10. The stacking section 16 thereby lifts the stage 16T and a banknote bundle further toward the upper side than the upper face of the storage casing 10 by moving the stage 16T upward in a state in which the banknote bundle has been placed on the stage 16T.

The reject storage box 17 is positioned toward the rear side of the uppermost side inside the storage casing 10 and is formed with a storage space 17S that stores banknotes internally. The storage space 17S is partitioned into an upper rear side and a lower front side by a partitioning plate 17P. Moreover, a discharge section 17R for discharging banknotes conveyed from the switching section 15 into the storage space 17S is provided toward the top of the front side of the reject storage box 17. The reject storage box 17 accordingly stores banknotes (namely, reject banknotes) that have been conveyed from the switching section 15 and discharged into the storage space 17S by the discharge section 17R.

Moreover, an upper face of the reject storage box 17 is provided with an intake hole 17H penetrating in the up-down direction over a range corresponding to the storage space 17S. The front-rear direction length of the intake hole 17H is substantially equal to the front-rear direction length of the stacking hole 16H of the stacking section 16. The intake hole 17H also penetrates an upper face of the storage casing 10, and places the storage space 17S in communication with a space further toward the upper side than the storage casing 10. Banknotes that fall from above are thereby stored in the storage space 17S of the reject storage box 17.

The reject storage box 17, similarly to the banknote storage boxes 11, is detached from the storage casing 10 by being pulled out toward the rear with respect to the storage casing 10. The reject storage box 17 is mounted in the storage casing 10 by being positioned with respect to the storage casing 10 and being pushed in toward the front.

Here, consider an imaginary center line C (FIG. 2) positioned along the front-rear direction center of the storage casing 10 of the storage unit 2. A front-rear direction distance from the center line C to the stacking hole 16H is substantially equal to the front-rear direction distance from the center line C to the intake hole 17H. Namely, the front-rear direction lengths of the stacking hole 16H and the intake hole 17H of the storage unit 2 are substantially equal to each other, and their distances from the center line C are substantially equal to each other, and so the stacking hole 16H and the intake hole 17H are formed with substantial front-rear symmetry.

By pointing a pay-out port 26 of the bundle conveyance unit 3 toward either the front side or the rear side, respectively aligning the stacking hole 16H and the intake hole 17H with either a front passage hole 20HF and a rear passage hole 20HR, or vice-versa, and attaching the pay-out port 26 to the storage unit 2, the banknote pay-out device 1 can accordingly be assembled in two configurations: as a front-facing machine with the pay-out port 26 provided to the front side or as a rear-facing machine with the pay-out port 26 provided to the rear side.

1-3. Configuration of Bundle Conveyance Unit

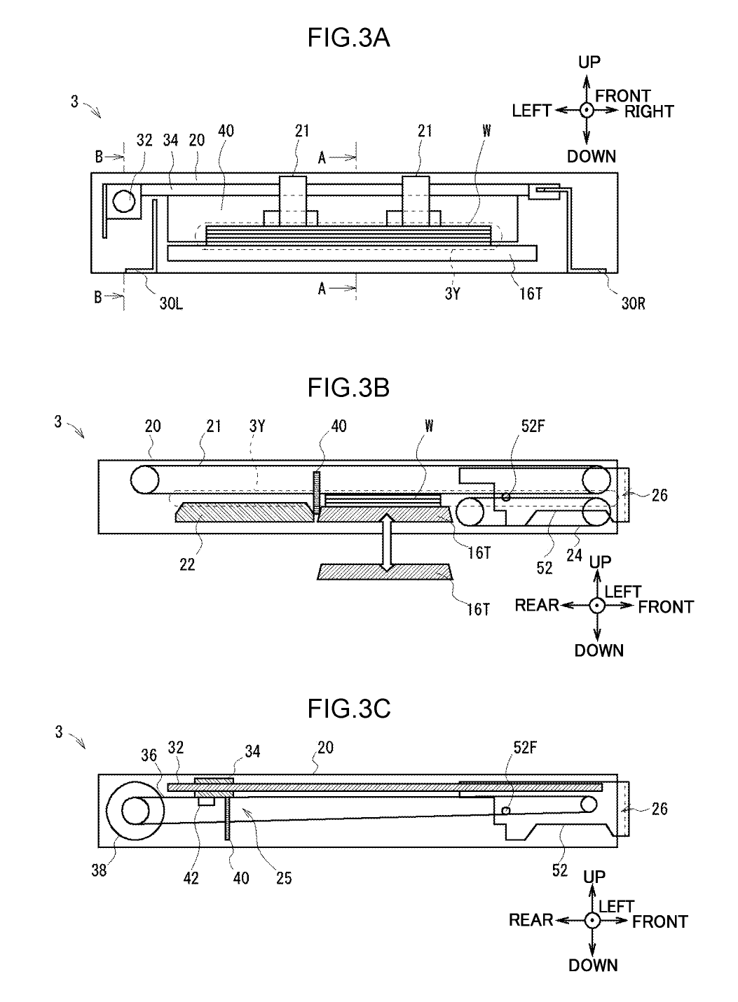

Overall, the bundle conveyance unit 3 illustrated in FIG. 3 is short in the up-down direction and long in the front-rear direction, is formed in a flattened rectangular block shape, and has a front-rear direction length longer than that of the storage unit 2. A rectangular block shaped bundle conveyance casing 20 of the bundle conveyance unit 3 is internally provided with various mechanisms to convey banknote bundles.

Upper belts 21 are provided at an upper-side portion inside the bundle conveyance casing 20. The upper belts 21 are endless belts entrained around the peripheries of respective rollers disposed in the vicinity of a rear end and in the vicinity of a front end of the upper belts 21, and when the rollers are rotated, lower faces of the upper belts 21 travel along the front-rear direction. For ease of explanation, in the following explanation, the direction of travel of the lower face portions of the upper belts 21 is taken as the direction of travel of the upper belts 21.

A large hole 20H (FIG. 2) is a large hole provided in a lower face of the bundle conveyance casing 20 over a wide range spanning from the vicinity of a front-rear direction center to the rear side of the bundle conveyance casing 20. Within the range of the large hole 20H, a gripping conveyance guide 22 is provided at a portion inside the bundle conveyance casing 20 further to the lower side than the upper belts 21. The gripping conveyance guide 22 is formed in a flattened rectangular block shape that is thin in the up-down direction, and an upper face of the gripping conveyance guide 22 faces the lower faces of the upper belts 21.

Moreover, the gripping conveyance guide 22 moves in the front-rear direction within the range of the large hole 20H using a non-illustrated moving mechanism. When the gripping conveyance guide 22 has moved to the front side, for example, a state is adopted in which the vicinity of the center and the front side of the large hole 20H are closed and a rear side range of the large hole 20H is open. The portion open at the rear side when this occurs is referred to hereafter as the rear passage hole 20HR. Moreover, when the gripping conveyance guide 22 has moved to the rear side, a state is adopted in which the vicinity of the center and the rear side of the large hole 20H are closed and a front side range of the large hole 20H is open. The portion open at the front side when this occurs is referred to hereafter as the front passage hole 20HF.

At a portion inside the bundle conveyance casing 20 further to the lower side than the upper belts 21, lower belts 24, these being endless belts, is provided further to the front side than the large hole 20H. The lower belts 24 are configured shorter than the upper belts 21 in the front-rear direction, and upper faces of the lower belts 24 face the lower faces of the upper belts 21 and travel in the front-rear direction. For ease of explanation, in the following explanation, the direction of travel of upper face portions of the lower belts 24 is taken as the direction of travel of the lower belts 24.

Moreover, in a state in which the gripping conveyance guide 22 has moved toward the rear (FIG. 1 and FIG. 2), the unclosed, open front passage hole 20HF of the large hole 20H is closed by the stage 16T when the stage 16T of the stacking section 16 is moved upward. When this occurs, in the bundle conveyance unit 3, a bundle conveyance path 3Y is formed interposed in the up-down direction between the upper belts 21; and the stage 16T, the gripping conveyance guide 22, and the lower belts 24.

A bundle conveyance frame 30L and a bundle conveyance frame 30R (referred to collectively as a bundle conveyance frame 30 below), these being metal plates fixed to the bundle conveyance casing 20, are respectively provided internally to a left side and a right side of the bundle conveyance unit 3 (see FIG. 3). At the left side of the bundle conveyance frame 30L, a circular cylinder shaped slide shaft 32 that extends along the front-rear direction, this being the conveyance direction of a banknote bundle W, is fixed to the bundle conveyance frame 30L. A push-out section frame 34 that spans in the left-right direction from an outer side on the left side to an outer side on the right side of the bundle conveyance path 3Y is provided at an upper side of the bundle conveyance path 3Y. A left end of the push-out section frame 34 is inserted into and supported by the slide shaft 32 so as to be capable of sliding, and a right end of the push-out section frame 34 is supported by the bundle conveyance frame 30R so as to be capable of sliding.

As illustrated in FIG. 3C, a push-out section drive belt 36, serving as a drive mechanism, is provided to the left side of the bundle conveyance frame 30L. The push-out section drive belt 36 is an endless belt entrained around the peripheries of respective rollers disposed in the vicinity of a rear end and in the vicinity of a front end of the push-out section drive belt 36 so as to run parallel to the slide shaft 32. The push-out section drive belt 36 rotates and moves when the rollers are rotated. At the rear of the push-out section drive belt 36, a push-out section drive motor 38, serving as a drive source, is fixed to the bundle conveyance frame 30. Drive force is transmitted to the rear roller around which the push-out section drive belt 36 is entrained, thereby rotating the roller. Note that the push-out section drive belt 36 and the push-out section drive motor 38 are omitted from illustration in FIG. 3A.

The push-out section frame 34 belongs to a push-out section 25 and is fixed to the push-out section drive belt 36 by a belt clamp 42. The push-out section 25 is configured by the push-out section frame 34 and a push-out plate 40. The push-out plate 40 is plate shaped and is provided to the push-out section frame 34 at a location positioned at the upper side of the bundle conveyance path 3Y so as to project out downward from the push-out section frame 34. A portion of the push-out plate 40 projects out further downward than the lower faces of the upper belts 21. Due to drive force from the push-out section drive motor 38, the push-out plate 40 moves along the front-rear direction, namely, along the bundle conveyance path 3Y. Namely, the push-out plate 40 pushes a rear edge of a banknote bundle W by moving together with the push-out section frame 34 toward a pay-out direction (forward), while preventing bundle slippage of the banknote bundle W, and preventing banknotes from remaining behind, and the like. The push-out plate 40 also pushes a front edge of the banknote bundle W by moving together with the push-out section frame 34 toward a take-in direction, while preventing bundle slippage of the banknote bundle W, preventing banknotes from remaining behind, and the like. The push-out plate 40 is displaced in the up-down direction with respect to the push-out section frame 34 by a displacement mechanism, not illustrated in the drawings. Namely, as illustrated in FIG. 3B, in addition to part of the push-out plate 40 being lowered further downward than the lower faces of the upper belts 21, the push-out plate 40 is also displaced further upward than the lower faces of the upper belts 21 as described below.

The push-out plate 40 only projects out further downward than the lower faces of the upper belts 21 at a number of discrete locations in the left-right direction. Gaps, grooves, or the like corresponding to the push-out plate 40 are formed along the front-rear direction in the gripping conveyance guide 22 and the lower belts 24, and in the stage 16T of the stacking section 16 of the storage unit 2 so as not to interfere with the push-out plate 40. Thus, when there is a banknote bundle W in the bundle conveyance path 3Y, the push-out plate 40 pushes the banknote bundle W so as to move the banknote bundle W along the front-rear direction.

The pay-out port 26 that hands over to a user the banknote bundle W conveyed toward the front within the bundle conveyance path 3Y, is formed in a front end of the bundle conveyance casing 20. A shutter 52 that opens and closes the pay-out port 26 with respect to the outside by swinging about a shutter fulcrum 52F is provided in the vicinity of the pay-out port 26.

A pay-out port sensor 27 (see FIG. 1 and FIG. 2) that detects banknote bundles W is provided in the vicinity of the pay-out port 26. The pay-out port sensor 27 is an optical sensor configured by combining a light emitting element that emits a predetermined detection light and a light receiving element that receives this detection light. The optical path of the detection light intersects the bundle conveyance path 3Y. The pay-out port sensor 27 notifies the controller 4 of the detection light reception results. The controller 4 determines whether or not there is a banknote bundle W in the pay-out port 26 based on the light reception results.

When not paying out banknotes to a user, the banknote pay-out device 1 protects the internally stored banknotes by locking the shutter 52 in a state in which pay-out port 26 is closed to the outside. On the other hand, during a pay-out operation to pay out a banknote bundle W to a user, the banknote pay-out device 1 pays out the banknote bundle W by releasing the lock on the shutter 52, swinging the shutter 52, and opening the pay-out port 26 to the outside.

1-4. Configuration of Shutter Opening-and-Closing Mechanism

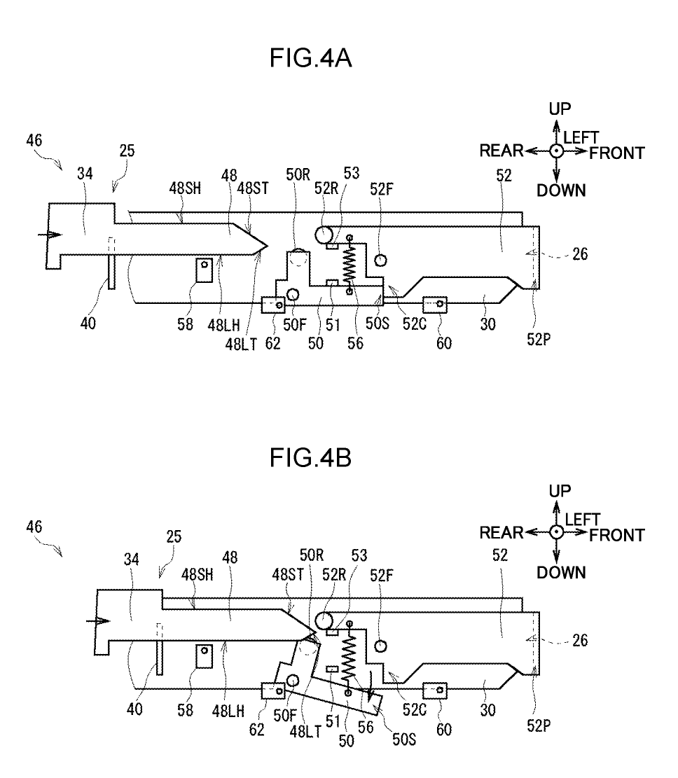

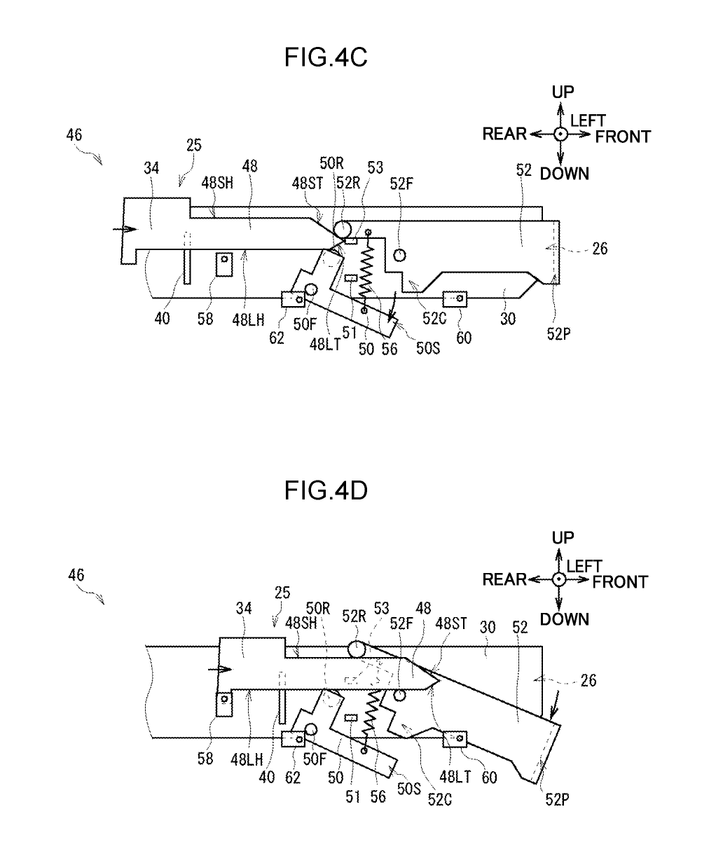

As in FIG. 4A, illustrating a locked state in which a locking lever 50 serving as a locking member is latching the shutter 52, a shutter opening-and-closing mechanism 46 is broadly configured by the locking lever 50 that latches the shutter 52, and by the push-out section frame 34 that abuts the locking lever 50 to release locking and that opens the shutter 52.

A plate shaped shutter opening-and-closing projection 48 provided projecting toward the front is formed at a front end portion of the push-out section frame 34. By integrally forming the shutter opening-and-closing projection 48 to the push-out section frame 34, the opening-and-closing projection 48 moves back and forth together with the push-out section frame 34 in the pay-out direction and the take-in direction.

The shutter opening-and-closing projection 48 is formed with a shutter retention horizontal face 48SH, this being a flat face running along a horizontal direction at an upper end face of the shutter opening-and-closing projection 48, and with a locking lever retention horizontal face 48LH, this being a flat face running along the horizontal direction at a lower end face of the shutter opening-and-closing projection 48. A shutter-swinging inclined face 48ST, this being a flat face inclined downward on progression toward the front, is formed from a front end portion of the shutter retention horizontal face 48SH, and a locking lever-swinging inclined face 48LT, this being a flat face inclined upward on progression toward the front, is formed from a front end portion of the locking lever retention horizontal face 48LH, respectively. Hereafter, the shutter-swinging inclined face 48ST and the locking lever-swinging inclined face 48LT are collectively referred to as shutter opening member inclined faces, and the shutter retention horizontal face 48SH and the locking lever retention horizontal face 48LH are collectively referred to as shutter opening member horizontal faces.

The locking lever 50 is a substantially L-shaped member in side view and is formed by a metal plate. The locking lever 50 is positioned below a rear side of the shutter 52 and below a front side of the shutter opening-and-closing projection 48 when in a non-pay-out position (see FIG. 4A, FIG. 4B, and FIG. 4C), this being a position further toward the rear side than a pay-out position (see FIG. 4D) that is the position adopted by the shutter opening-and-closing projection 48 when a banknote bundle W is paid out.

At the rear of the locking lever 50, a circular cylinder shaped locking lever fulcrum 50F fixed to the bundle conveyance frame 30 is inserted through the locking lever 50 in the left-right direction. The locking lever 50 is thereby configured so as to be capable of swinging clockwise and counterclockwise in FIGS. 4, about the locking lever fulcrum 50F. Hereafter, swinging of the locking lever 50 clockwise, this being the direction of lock release, is also referred to as the unlocking direction, and swinging of the locking lever 50 counterclockwise, this being the direction to engage the lock, is also referred to as the locking direction. Moreover, due to attaching a lower end of a reset spring 56, which is a tension spring whose upper end is attached to the shutter 52, in front of the locking lever fulcrum 50F of the lock lever 50, a force is applied to the locking lever 50 that biases the locking lever 50 about the locking lever fulcrum 50F in the locking direction.

A locking lever limiter 51 fixed to the bundle conveyance frame 30 is provided to an upper side of the locking lever 50, in front of the locking lever fulcrum 50F. In the locked state, the locking lever limiter 51 abuts the upper side of the locking lever 50, in front of the locking lever fulcrum 50F. When in the locked state, the locking lever 50 is thus suppressed from swinging any further in the locking direction and is positioned at a predetermined swinging position, because of the locking lever 50 abutting the locking lever limiter 51 while being biased in the locking direction by biasing force of the reset spring 56.

At the right side of the upper side of the locking lever fulcrum 50F, a circular cylinder shaped locking lever roller 50R is rotatably attached to the locking lever 50. The locking lever roller 50R faces the locking lever-swinging inclined face 48LT of the shutter opening-and-closing projection 48 in the front-rear direction so as to be at the same up-down position (height) as the locking lever-swinging inclined face 48LT.

In a closed state and the locked state, a swing restriction portion 50S at a front end portion of the locking lever 50 enters into the swing path of the shutter 52, and since the swing restriction portion 50S abuts an abutment portion 52c of the shutter 52, the swing restriction portion 50S obstructs swinging of the shutter 52 toward an opening direction. Namely, when force toward the opening direction is applied to a shutter plate 52P of the shutter 52 in the closed state, force toward the rear is transferred from the abutment portion 52c of the shutter plate 52P to the swing restriction portion 50S of the locking lever 50. When this occurs, the locking lever fulcrum 50F is positioned to the rear of the swing restriction portion 50S, and force from the swing restriction portion 50S toward the rear is applied to the locking lever fulcrum 50F, such that locking lever 50 does not swing.

The plate shaped shutter plate 52P that is longer in length than the pay-out port 26 in the left-right direction and the up-down direction, is formed to the front end of the shutter 52 so as to cover the front side of the pay-out port 26.

In the rear of the shutter 52, the circular cylinder shaped shutter fulcrum 52F fixed to the bundle conveyance frame 30 is inserted in the left-right direction. The shutter 52 is thereby configured so as to be capable of swinging clockwise and counterclockwise in FIGS. 4, about the shutter fulcrum 52F. Hereafter, swinging of the shutter 52 clockwise, this being the direction to open the pay-out port 26, is also referred to as the opening direction, and swinging of the shutter 52 counterclockwise, this being the direction to close off the pay-out port 26, is referred to as the closing direction. Moreover, due to attaching an upper end of the reset spring 56, which is a tension spring whose lower end is attached to the locking lever 50, at the rear of the shutter fulcrum 52F of the shutter 52, a force is applied to the shutter 52 that biases the shutter 52 about the shutter fulcrum 52F in the closing direction.

A shutter limiter 53 fixed to the bundle conveyance frame 30 is provided to a lower side of the shutter 52, at the rear of the shutter fulcrum 52F. In the closed state, the shutter limiter 53 abuts the lower side of the shutter 52, at the rear of the shutter fulcrum 52F. The shutter 52 is thus suppressed from swinging any further in the closing direction and positioned at a predetermined swinging position, since in the closed state, the shutter 52 abuts the shutter limiter 53 while being biased in the closing direction by biasing force of the reset spring 56.

A circular cylinder shaped shutter roller 52R is rotatably attached to a left side of the upper side of the shutter 52, at the rear of the shutter fulcrum 52F. The shutter roller 52R faces the shutter-swinging inclined face 48ST of the shutter opening-and-closing projection 48 in the front-rear direction so as to be at the same up-down position (height) as the shutter-swinging inclined face 48ST.

A push-out plate detection sensor 58 that detects the push-out section frame 34 is provided on the movement path of the push-out section frame 34. The push-out plate detection sensor 58 is a U-shaped optical sensor with a light emitting portion that emits detection light and a light receiving portion that receives the detection light disposed on the left and on the right of a groove through which the push-out section frame 34 is allowed to pass. The push-out plate detection sensor 58 notifies the controller 4 of detection light reception results. Based on the light reception results, the controller 4 determines whether or not the push-out plate 40 is at the pay-out position which serves as a handover position.

A locking lever detection sensor 62 that detects the locking lever 50 is provided on the movement path of the locking lever 50. The locking lever detection sensor 62 is an optical sensor similar to the push-out plate detection sensor 58. The locking lever detection sensor 62 notifies the controller 4 of detection light reception results. The controller 4 determines whether or not the locking lever 50 is in the locked state based on the light reception results.

A shutter detection sensor 60 that detects the shutter 52 is provided on the movement path of the shutter 52. The shutter detection sensor 60 is an optical sensor similar to the push-out plate detection sensor 58. The shutter detection sensor 60 notifies the controller 4 of detection light reception results. The controller 4 determines whether or not the shutter 52 is the open state based on the light reception results.

1-5. Operation of Shutter Opening-and-Closing Mechanism

The banknote pay-out device 1 (see FIG. 1) passes a banknote bundle W from the stacking section 16 to the bundle conveyance unit 3 and drives the upper belts 21, and the banknote pay-out device 1 moves the push-out section 25 toward the pay-out direction, this being a direction along the horizontal direction toward the front, from the bundle conveyance path 3Y at an upper portion of the front passage hole 20HF to the pay-out port 26. The banknote bundle W is thus conveyed from the stage 16T toward the pay-out direction in the state illustrated in FIG. 4A. In this state, the push-out plate 40 is in the non-pay-out position, the locking lever 50 is in the locked state, and the shutter 52 is in the closed state. Note that the banknote bundle W is omitted from illustration in FIGS. 4.

In this state, the push-out plate detection sensor 58 notifies the controller 4 of a light reception result indicating that the detection light is being received. The controller 4 determines that the push-out plate 40 is in the non-pay-out position based on this light reception result. The locking lever detection sensor 62 notifies the controller 4 of a light reception result indicating that the detection light is not being received. The controller 4 determines that the locking lever 50 is in the locked state based on this light reception result. The shutter detection sensor 60 notifies the controller 4 of a light reception result indicating that the detection light is being received. The controller 4 determines that the shutter 52 is in the closed state based on this light reception result.

When the push-out section 25 (namely, the shutter opening-and-closing projection 48) is moved toward the pay-out direction from this state, the locking lever-swinging inclined face 48LT of the shutter opening-and-closing projection 48 abuts the locking lever roller 50R of the locking lever 50. When the shutter opening-and-closing projection 48 is moved further toward the pay-out direction, as illustrated in FIG. 4B, the locking lever-swinging inclined face 48LT of the shutter opening-and-closing projection 48 presses down the locking lever roller 50R of the locking lever 50, and so the locking lever 50 swings toward the unlocking direction against the biasing force of the reset spring 56. The swing restriction portion 50S of the locking lever 50 thus moves further to the lower side than the abutment portion 52c of the shutter 52. Accordingly, the swing restriction portion 50S retracts from the path along which the shutter 52 swings in the opening direction and a non-locked state is adopted in which swinging of the shutter 52 toward the opening direction is unobstructed. In this state, the locking lever detection sensor 62 notifies the controller 4 of a light reception result indicating that the detection light is being received. The controller 4 determines that the locking lever 50 is in the non-locked state based on this light reception result.

When the shutter opening-and-closing projection 48 is moved further toward the pay-out direction, as illustrated in FIG. 4C, the shutter-swinging inclined face 48ST of the shutter opening-and-closing projection 48 abuts the shutter roller 52R of the shutter 52. When this occurs, the locking lever roller 50R of the locking lever 50 moves toward the lower side while contacting the locking lever-swinging inclined face 48LT of the shutter opening-and-closing projection 48. Accordingly, the locking lever 50 swings toward the unlocking direction and the locking lever roller 50R rides under the locking lever retention horizontal face 48LH.

When the shutter opening-and-closing projection 48 is moved further toward the pay-out direction, the shutter roller 52R of the shutter 52 is pressed up by the shutter-swinging inclined face 48ST of the shutter opening-and-closing projection 48. Accordingly, the shutter 52 is caused to swing toward the opening direction against the biasing force of the reset spring 56, such that an open state is adopted.

When the shutter opening-and-closing projection 48 is moved further toward the pay-out direction, as illustrated in FIG. 4D, the shutter roller 52R of the shutter 52 moves toward the upper side while contacting the shutter-swinging inclined face 48ST of the shutter opening-and-closing projection 48. Accordingly, the shutter 52 swings toward the opening direction and the shutter roller 52R rides over the shutter retention horizontal face 48SH. When this occurs, the shutter roller 52R of the shutter 52 abuts the shutter retention horizontal face 48SH of the shutter opening-and-closing projection 48 while being biased toward the closing direction by biasing force of the reset spring 56, such that swinging of the shutter 52 toward the closing direction is restricted. The shutter opening-and-closing projection 48 thus retains the shutter 52 in the open state. In this state, the shutter detection sensor 60 notifies the controller 4 of a light reception result indicating that detection light is not being received. The controller 4 determines that the shutter 52 is in the open state based on this light reception result.

When this is performed, the locking lever roller 50R of the locking lever 50 abuts the locking lever retention horizontal face 48LH of the shutter opening-and-closing projection 48 while being biased toward the locking direction by the biasing force of the reset spring 56, such that swinging of the locking lever 50 toward the locking direction is restricted. The shutter opening-and-closing projection 48 accordingly retains the locking lever 50 in the non-locked state.

When in the state illustrated in FIG. 4D, the push-out plate detection sensor 58 notifies the controller 4 of a light reception result indicating that detection light is not being received. The controller 4 determines that the push-out plate 40 is in the pay-out position based on this light reception result. In cases in which the push-out plate 40 has been determined to be at the pay-out position, the controller 4 stops movement of the push-out section 25 and drives the upper belts 21 and the lower belts 24 (see FIG. 1 and FIG. 2) toward the front, such that the banknote bundle W progresses toward the front along the bundle conveyance path 3Y to expose part of the banknote bundle W in the pay-out port 26, in a state in which the vicinity of the rear end of the banknote bundle W is gripped between the upper belts 21 and the lower belts 24 and which allows a user to take the banknote bundle W. In this manner, the banknote pay-out device 1 performs shutter opening operation by transitioning the locking lever 50 from the locked state to the non-locked state, and transitioning the shutter 52 from the closed state to the open state.

On the other hand, when closing the shutter 52 in the open state, from the state illustrated in FIG. 4D, the banknote pay-out device 1 moves the push-out section 25 toward the take-in direction, this being a direction along the horizontal direction toward the rear, from the pay-out port 26 toward the bundle conveyance path 3Y at an upper portion of the rear passage hole 20HR and the front passage hole 20HF. Accordingly, the shutter opening-and-closing projection 48 is first separated from the shutter 52, thereby swinging the shutter 52 such that the closed state is adopted; and then the push-out section 25 is moved further toward the take-in direction, causing the shutter opening-and-closing projection 48 to separate from the locking lever 50, thereby swinging the locking lever 50 such that the locked state is adopted. Namely, the banknote pay-out device 1 performs the opposite operation to the shutter opening operation described above, i.e. performs a shutter closing operation by transitioning the shutter 52 from the open state to the closed state and by transitioning the locking lever 50 from the non-locked state to the locked state.

1-6. Operation of Banknote Pay-Out Device

Explanation follows regarding pay-out operation of the banknote pay-out device 1. On receipt of a pay-out instruction and a pay-out amount from a user operating an operation section, not illustrated in the drawings, the banknote pay-out device 1 begins processing according to this configuration by reading and executing a control program and the like, under control of the controller 4.

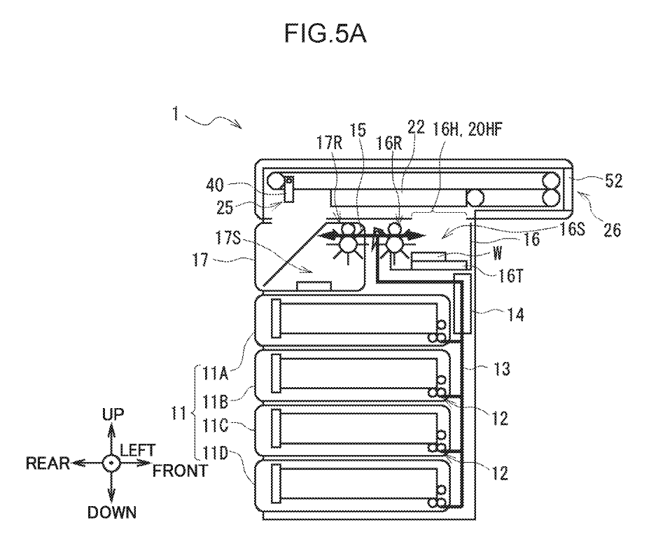

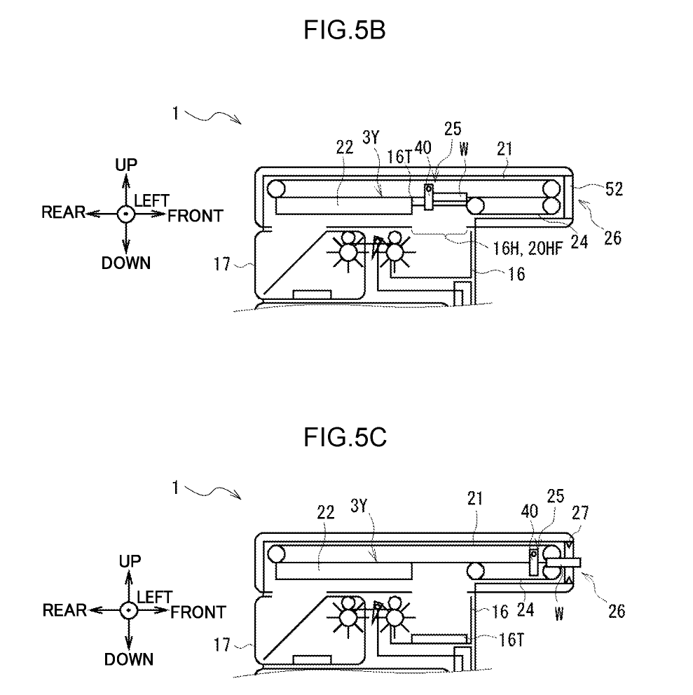

As illustrated in FIG. 5A, first, the controller 4 moves the stage 16T downward and closes the stacking hole 16H of the stacking section 16 and the front passage hole 20HF by moving the gripping conveyance guide 22 toward the front. Moreover, the controller 4 moves the push-out plate 40 to the rearmost side.

In this state, the controller 4 feeds out banknotes in sequence from the banknote storage boxes 11 in the denominations and the numbers corresponding to the pay-out amount using the feed-out sections 12, conveys the banknotes upward using the conveyance section 13, and classifies the banknotes using the classification section 14. When this is performed, based on the classification results obtained from the classification section 14, the controller 4 decides the conveyance destination to be either the stacking section 16 or the reject storage box 17 according to whether or not the banknotes can be paid out. Next, the controller 4 conveys the banknotes that were classified by the classification section 14 to the rear and upward using the conveyance section 13 such that the banknotes reach the switching section 15. Under control of the controller 4, the switching section 15 switches the direction of travel for each banknote according to their respective decided conveyance destination, causing each banknote to travel toward either the stacking section 16 or the reject storage box 17.

In the stacking section 16, the conveyed banknotes are discharged into the stacking space 16S by the discharge section 16R and are stacked upon the stage 16T. When this is performed, the stacking section 16 prevents the banknotes discharged from the discharge section 16R from floating upward and stably stacks the banknotes upon the stage 16T, since the top of the stacking hole 16H is closed off by the gripping conveyance guide 22. In the reject storage box 17, conveyed banknotes are discharged into the storage space 17S by the discharge section 17R and stored.

The controller 4 continuously tallies the denominations and numbers of banknotes with a conveyance destination of the stacking section 16, namely, banknotes stacked in the stacking section 16, and stops feeding banknotes out from the banknote storage boxes 11 at a stage when the tallied amount has reached the pay-out amount. A banknote bundle W, in which banknotes corresponding to the pay-out amount are stacked in the form of a loose bundle, is thereby placed on the stage 16T of the stacking section 16.

Next, as illustrated in FIG. 5B, the controller 4 opens the stacking hole 16H of the stacking section 16 and the front passage hole 20HF by moving the gripping conveyance guide 22 toward the rear, and then lifts the banknote bundle W by moving the stage 16T of the stacking section 16 upward. When this is performed, the controller 4 aligns the upper face of the stage 16T to the same height as the upper face of the gripping conveyance guide 22, such that part of the bundle conveyance path 3Y is configured by the stage 16T, and such that the banknote bundle W on the stage 16T is positioned on the bundle conveyance path 3Y.

Moreover, the controller 4 drives the upper belts 21 and the lower belts 24 toward the front and moves the push-out plate 40 toward the front, thereby moving the banknote bundle W toward the front along the bundle conveyance path 3Y. When this is performed, the shutter opening-and-closing projection 48 (FIGS. 4) of the push-out section 25 disposes the locking lever 50 in the non-locked state and disposes the shutter 52 in the open state. Eventually, when the banknote bundle W is detected as having reached the pay-out port 26 based on notification from the pay-out port sensor 27, the controller 4 stops driving of the upper belts 21 and the lower belts 24, as illustrated in FIG. 5C. Note that, the controller 4 moves the stage 16T downward when this is performed, ending the pay-out operation.

The banknote pay-out device 1 can thereby allow the user to take out the banknote bundle W, in a state in which part of the banknote bundle W is exposed from the pay-out port 26, and the vicinity of a rear edge of the banknote bundle W is gripped between the upper belts 21 and the lower belts 24.

The controller 4 monitors whether or not the banknote bundle W has been taken out from the pay-out port 26 based on notification from the pay-out port sensor 27, and in cases in which the banknote bundle W has not been taken out even after a predetermined standby time has elapsed (for example, 30 seconds), the controller 4 begins a take-in operation to take in the banknote bundle W.

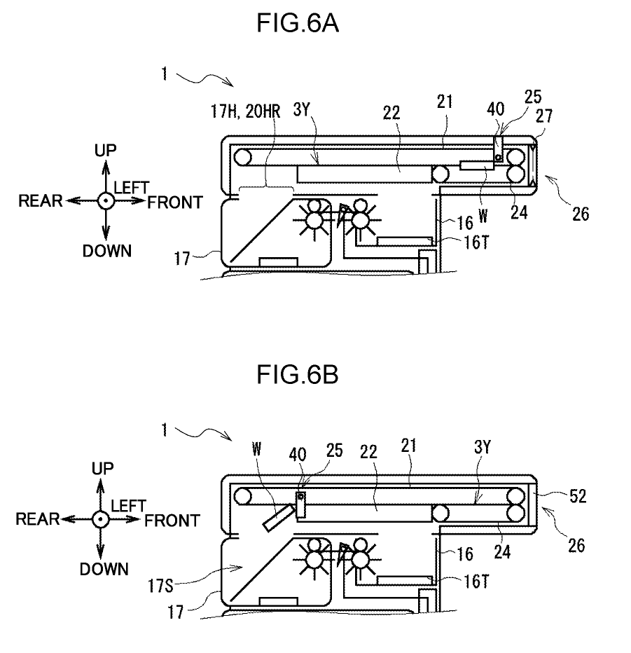

Specifically, as illustrated in FIG. 6A, first, the controller 4 moves the gripping conveyance guide 22 toward the front to open the rear passage hole 20HR and the intake hole 17H. Next, after displacing the push-out plate 40 upward, the controller 4 drives the upper belts 21 and the lower belts 24 toward the rear such that the banknote bundle W is taken into the bundle conveyance path 3Y and the banknote bundle W travels toward the rear along the bundle conveyance path 3Y. When this is performed, when the controller 4 detects that the banknote bundle W has reached a location further to the rear than the push-out plate 40 using a non-illustrated sensor, the controller 4 displaces the push-out plate 40 downward and moves the push-out plate 40 toward the rear so as to assist conveyance of the banknote bundle W toward the rear.

Eventually, as illustrated in FIG. 6B, when the banknote bundle W reaches the rear passage hole 20HR and the intake hole 17H, the controller 4 causes the banknote bundle W to fall from the bundle conveyance path 3Y, stores the banknote bundle W in the storage space 17S of the reject storage box 17, and ends the take-in operation. Thus, the banknote pay-out device 1 takes in a banknote bundle W that a user forgot to take from the pay-out port 26, and stores the banknote bundle W in the reject storage box 17.

1-7. Advantageous Effects

In the above configuration, to pay out a banknote bundle W, the banknote pay-out device 1 moves the push-out section 25 toward the pay-out direction, causing the shutter opening-and-closing projection 48 to first abut the locking lever 50 such that the locking lever 50 swings. Thus, the banknote pay-out device 1 moves the swing restriction portion 50S of the locking lever 50 further to the lower side than the abutment portion 52c of the shutter 52, such that the non-locked state is adopted. The push-out section 25 is further moved toward the pay-out direction, causing the shutter opening-and-closing projection 48 to abut the shutter 52 such that the shutter 52 swings, thereby moving the shutter plate 52P further to the lower side than the pay-out port 26 such that the open state is adopted.

The banknote pay-out device 1 can accordingly utilize the operation of moving the push-out section 25 toward the pay-out direction while pushing the rear edge of the banknote bundle W using the push-out plate 40, such that the locking lever 50 is disposed in the non-locked state and the shutter 52 is disposed in the open state when paying out the banknote bundle W.

When closing the shutter 52 in the open state after the banknote bundle W has been paid out, the banknote pay-out device 1 moves the push-out section 25 from the pay-out position toward the take-in direction to first separate the shutter opening-and-closing projection 48 from the shutter 52 to allow the shutter 52 to swing, such that the closed state is adopted. The banknote pay-out device 1 further moves the push-out section 25 toward the take-in direction to separate the shutter opening-and-closing projection 48 from the locking lever 50 to allow the locking lever 50 to swing, such that the locked state is adopted.

The banknote pay-out device 1 can accordingly utilize the operation of moving the push-out section 25 from the pay-out port 26 toward the take-in direction after paying out the banknote bundle W, such that the shutter 52 is disposed in the closed state and the locking lever 50 is disposed in the locked state.

Accordingly, in the banknote pay-out device 1, the opening and closing operation of the shutter 52 can be performed utilizing the push-out section 25 already provided to the banknote pay-out device 1 to pay out the banknote bundle W, without providing a dedicated drive source to drive the shutter 52 that opens and closes the pay-out port 26, nor a dedicated drive source to drive the locking lever 50 that retains the shutter 52 in the closed state. This enables configuration to be simplified and enables a reduction in costs. Moreover, the banknote pay-out device 1 can be made smaller since there is no need to provide the banknote pay-out device 1 with a space inside the storage casing 10 for installing an actuator that is a drive source to drive the shutter 52 that opens and closes the pay-out port 26 and an actuator that is a drive source to drive the locking lever 50.

In the above configuration, the banknote pay-out device 1 is provided with the pay-out port 26 that hands over a banknote bundle W of a superimposed, paper sheet shaped medium to a user, a shutter provided so as to be capable of closing or opening the pay-out port 26, and the gripping conveyance guide 22 and the stage 16T that guide the banknote bundle W. The banknote pay-out device 1 is also provided with the push-out plate 40 that is disposed facing the gripping conveyance guide 22 and the stage 16T, and that moves in the handover direction toward the pay-out port 26 while contacting one edge side of the banknote bundle W to convey the banknote bundle W toward the pay-out port 26, and with the shutter opening-and-closing projection 48 that, 26 as the push-out plate 40 moves toward the pay-out port 26, moves together with the push-out plate 40 and that moves the shutter 52 toward the opening direction to open the pay-out port 26.

The banknote pay-out device 1 can thereby open and close the shutter 52 utilizing drive force from the push-out section drive motor 38, i.e. without providing a drive source to open and close the shutter 52 separate from the push-out section drive motor 38, this being the drive source to drive the push-out section 25.

### 2. Second Exemplary Embodiment 2-1. Configuration of Banknote Pay-out Device and Bundle Conveyance Unit

As illustrated in FIG. 1 and FIG. 2, a banknote pay-out device 101 according to a second exemplary embodiment has the same configuration as the banknote pay-out device 1 according to the first exemplary embodiment except for a bundle conveyance unit 103 that differs from the bundle conveyance unit 3.

2-2. Configuration of Shutter Opening-and-Closing Mechanism

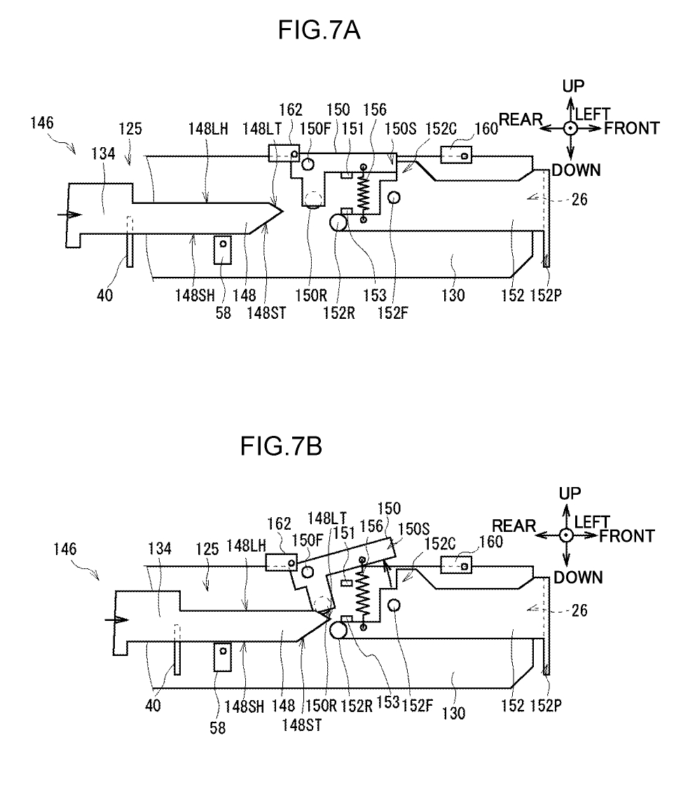

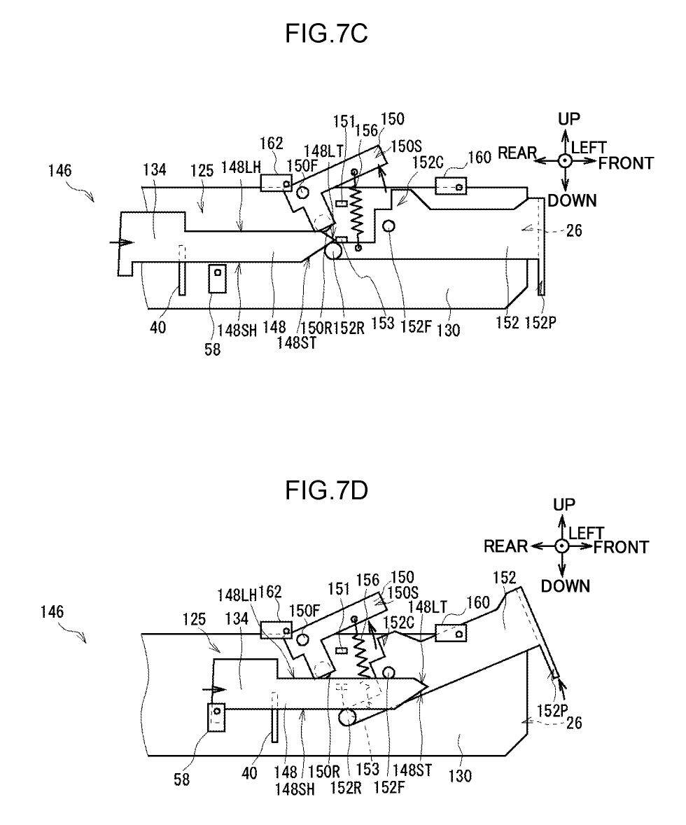

As illustrated in FIG. 7, which corresponds to FIG. 4, a shutter opening-and-closing mechanism 146 according to the second exemplary embodiment is configured such that the shutter opening-and-closing mechanism 46 according to first exemplary embodiment is substantially vertically inverted.

A plated-shaped shutter opening-and-closing projection 148 projecting out toward the front is formed at a front end portion of a push-out section frame 134. The shutter opening-and-closing projection 148 is formed with a shutter retention horizontal face 148SH, this being a flat face running along the horizontal direction at a lower end face of the shutter opening-and-closing projection 148, and with a locking lever retention horizontal face 148LH, this being a flat face running along the horizontal direction at an upper end face of the shutter opening-and-closing projection 148. A shutter-swinging inclined face 148ST, this being a flat face inclined upward on progression toward the front, is formed from a front end portion of the shutter retention horizontal face 148SH, and a locking lever-swinging inclined face 148LT, this being a flat face inclined downward on progression toward the front, is formed from a front end portion of the locking lever retention horizontal face 148LH, respectively.

A locking lever 150 is positioned above a rear side of a shutter 152 and above a front side of the shutter opening-and-closing projection 148 that is in a non-pay-out position (see FIG. 7A, FIG. 7B, and FIG. 7C), this being a position further toward the rear side than a pay-out position (see FIG. 7D).

At the rear of the lock lever 150, a circular cylinder shaped locking lever fulcrum 150F fixed to a bundle conveyance frame 130 is inserted through the locking lever 150 in the left-right direction. The locking lever 150 is thereby configured so as to be capable of swinging clockwise and counterclockwise in FIGS. 7, about the locking lever fulcrum 150F. Hereafter, swinging of the locking lever 150 counterclockwise, this being the direction of lock release, is also referred to as the unlocking direction, and swinging of the locking lever 150 clockwise, this being the direction to engage the lock, is also referred to as the locking direction. Moreover, due to attaching an upper end of a reset spring 156, which is a tension spring whose lower end is attached to the shutter 152, in front of the locking lever fulcrum 150F of the lock lever 150, a force is applied to the locking lever 150 that biases the locking lever 150 about the locking lever fulcrum 150F in the locking direction.

A locking lever limiter 151 fixed to the bundle conveyance frame 130 is provided to a lower side of the locking lever 150, in front of the locking lever fulcrum 150F. In a locked state, the locking lever limiter 151 abuts the lower side of the locking lever 150, in front of the locking lever fulcrum 150F. When in the locked state, the locking lever 150 is thus suppressed from swinging any further in the locking direction and is positioned at a predetermined swinging position, because of the locking lever 150 abutting the locking lever limiter 151 while being biased in the locking direction by the biasing force of the reset spring 156.

At the right side of the lower side of the locking lever fulcrum 150F, a circular cylinder shaped locking lever roller 150R is rotatably attached to the locking lever 150. The locking lever roller 150R faces the locking lever-swinging inclined face 148LT of the shutter opening-and-closing projection 148 in the front-rear direction so as to be at the same up-down position (height) as the locking lever-swinging inclined face 148LT.

In a closed state and the locked state, a swing restriction portion 1505 at a front end portion of the locking lever 150 enters into the swing path of the shutter 152, and since the swing restriction portion 1505 abuts an abutment portion 152C of the shutter 152, the swing restriction portion 1505 obstructs swinging of the shutter 152 toward the opening direction.

A plate shaped shutter plate 152P that is longer in length than the pay-out port 26 in the left-right direction and the up-down direction, is formed to the front end of the shutter 152 so as to cover the front side of the pay-out port 26.

In the rear of the shutter 152, a circular cylinder shaped shutter fulcrum 152F fixed to the bundle conveyance frame 130 is inserted in the left-right direction. The shutter 152 is thereby configured so as to be capable of swinging clockwise and counterclockwise in FIGS. 7, about the shutter fulcrum 152F. Hereafter, swinging of the shutter 152 counterclockwise, this being the direction to open the pay-out port 26, is also referred to as the opening direction, and swinging of the shutter 152 clockwise, this being the direction to close off the pay-out port 26, is also referred to as the closing direction. Moreover, due to an upper end of the reset spring 156, which is a tension spring whose upper end is attached to the locking lever 150, being attached at the rear of the shutter fulcrum 152F to the shutter 152, a force is applied to the shutter 152 that biases the shutter 152 about the shutter fulcrum 152F in the closing direction.

A shutter limiter 153 fixed to the bundle conveyance frame 130 is provided to an upper side of the shutter 152, at the rear of the shutter fulcrum 152F. In the closed state, the shutter limiter 153 abuts the upper side of the shutter 152, at the rear of the shutter fulcrum 152F. The shutter 152 is thus suppressed from swinging any further in the closing direction and positioned at a predetermined swinging position, since in the locked state, the shutter 152 abuts the shutter limiter 153 while being biased in the closing direction by the biasing force from the reset spring 156.

A circular cylinder shaped shutter roller 152R is rotatably attached to a left side of the lower side of the shutter 152, at the rear of the shutter fulcrum 152F. The shutter roller 152R faces the shutter-swinging inclined face 148ST of the shutter opening-and-closing projection 148 in the front-rear direction so as to be at the same up-down position (height) as the shutter-swinging inclined face 148ST.

A push-out plate detection sensor 58 that detects the push-out section frame 134 is provided on the movement path of the push-out section frame 134.

A push-out plate detection sensor 58 that detects the push-out section frame 134 is provided on the movement path of the push-out section frame 134.

A locking lever detection sensor 162 that detects the locking lever 150 is provided on the movement path of the locking lever 150. The locking lever detection sensor 162 is an optical sensor similar to the push-out plate detection sensor 58. The locking lever detection sensor 162 notifies the controller 4 of detection light reception results. The controller 4 determines whether or not the locking lever 150 is in the locked state based on the light reception results.

A shutter detection sensor 160 that detects the shutter 152 is provided on the movement path of the shutter 152. The shutter detection sensor 160 is an optical sensor similar to the push-out plate detection sensor 58. The shutter detection sensor 160 notifies the controller 4 of detection light reception results. The controller 4 determines whether or not the shutter 152 is the open state based on the light reception results.

2-3. Operation of Shutter Opening-and-Closing Mechanism

The banknote pay-out device 101 passes the banknote bundle W from the stacking section 16 to the bundle conveyance unit 103 and drives the upper belts 21, and the banknote pay-out device 101 moves the push-out section 125 toward the pay-out direction. The banknote bundle W is thus conveyed from the stage 16T toward the pay-out direction in the state illustrated in FIG. 7A. In this state, the push-out plate 40 is in the non-pay-out position, the locking lever 150 is in the locked state, and the shutter 152 is in the closed state. Note that the banknote bundle W is omitted from illustration in FIGS. 7.

In this state, the push-out plate detection sensor 58 notifies the controller 4 of a light reception result indicating that the detection light is being received. The controller 4 determines that the push-out plate 40 is in the non-pay-out position based on this light reception result. The locking lever detection sensor 162 notifies the controller 4 of a light reception result indicating that the detection light is not being received. The controller 4 determines that the locking lever 150 is in the locked state based on this light reception result. The shutter detection sensor 160 notifies the controller 4 of a light reception result indicating that the detection light is being received. The controller 4 determines that the shutter 152 is in the closed state based on this light reception result.

When the push-out section 125 (namely, the shutter opening-and-closing projection 148) is moved toward the pay-out direction from this state, the locking lever-swinging inclined face 148LT of the shutter opening-and-closing projection 48 abuts the locking lever roller 150R of the locking lever 150. When the shutter opening-and-closing projection 148 is moved further toward the pay-out direction, as illustrated in FIG. 7B, the locking lever-swinging inclined face 148LT of the shutter opening-and-closing projection 148 presses up the locking lever roller 150R of the locking lever 150, and so the locking lever 150 swings toward the unlocking direction against the biasing force of the reset spring 156. The swing restriction portion 1505 of the locking lever 150 thus moves further to the upper side than the abutment portion 152C of the shutter 152. Accordingly, the swing restriction portion 1505 retracts from the swing path toward the opening direction of the shutter 152 such that a non-locked state is adopted in which swinging of the shutter 152 toward the opening direction is unobstructed. In this state, the locking lever detection sensor 162 notifies the controller 4 of a light reception result indicating that the detection light is being received. The controller 4 determines that the locking lever 150 is in the non-locked state based on this light reception result.

When the shutter opening-and-closing projection 148 is moved further toward the pay-out direction, as illustrated in FIG. 7C, the shutter-swinging inclined face 148ST of the shutter opening-and-closing projection 148 abuts the shutter roller 152R of the shutter 152. When this occurs, the locking lever roller 150R of the locking lever 150 moves toward the upper side while contacting the locking lever-swinging inclined face 148LT of the shutter opening-and-closing projection 148. Accordingly, the locking lever 150 swings toward the unlocking direction and the locking lever roller 150R rides over the locking lever retention horizontal face 148LH.

When the shutter opening-and-closing projection 148 is moved further toward the pay-out direction, the shutter roller 152R of the shutter 152 is pressed down by the shutter-swinging inclined face 148ST of the shutter opening-and-closing projection 148. Accordingly, the shutter 152 is caused to swing toward the opening direction, against the biasing force of the reset spring 156, such that an open state is adopted.

When the shutter opening-and-closing projection 148 is moved further toward the pay-out direction, as illustrated in FIG. 7D, the shutter roller 152R of the shutter 152 moves toward the lower side while contacting the shutter-swinging inclined face 148ST of the shutter opening-and-closing projection 148. Accordingly, the shutter 152 swings toward the opening direction and the shutter roller 152R rides under the shutter retention horizontal face 148SH. When this occurs, the shutter roller 152R of the shutter 152 abuts the shutter retention horizontal face 148SH of the shutter opening-and-closing projection 148 while being biased toward the closing direction by the biasing force of the reset spring 156, such that swinging of the shutter 152 toward the closing direction is restricted. The shutter opening-and-closing projection 148 thus retains the shutter 152 in the open state. In this state, the shutter detection sensor 160 notifies the controller 4 of a light reception result indicating that detection light is not being received. The controller 4 determines that the shutter 152 is in the open state based on this light reception result.

When this is performed, the locking lever roller 150R of the locking lever 150 abuts the locking lever retention horizontal face 148LH of the shutter opening-and-closing projection 148 while being biased toward the locking direction by the biasing force of the reset spring 156, such that swinging of the locking lever 150 toward the locking direction is restricted. The shutter opening-and-closing projection 148 accordingly retains the locking lever 150 in the non-locked state.

When in the state illustrated in FIG. 7D, the push-out plate detection sensor 58 notifies the controller 4 of a light reception result indicating that detection light is not being received. The controller 4 determines that the push-out plate 40 is in the pay-out position based on this light reception result. In cases in which the push-out plate 40 has been determined to be at the pay-out position, the controller 4 stops movement of the push-out section 125 and drives the upper belt 21 and the lower belt 24 toward the front, such that the banknote bundle W progresses toward the front along the bundle conveyance path 3Y to expose part of the banknote bundle W in the pay-out port 26, allowing a user to take the banknote bundle W in a state in which the vicinity of the rear end of the banknote bundle W is gripped between the upper belt 21 and the lower belt 24. In this manner, the banknote pay-out device 101 performs shutter opening operation by transitioning the locking lever 150 from the locked state to the non-locked state, and transitioning the shutter 152 from the closed state to the open state.

On the other hand, when closing the shutter 152 in the open state, from the state illustrated in FIG. 7D, the banknote pay-out device 101 moves the push-out section 125 toward the take-in direction. Accordingly, the shutter opening-and-closing projection 148 is first separated from the shutter 152, thereby swinging the shutter 152 such that the closed state is adopted; and then the push-out section 125 is moved further toward the take-in direction, causing the shutter opening-and-closing projection 148 to separate from the locking lever 150, thereby swinging the locking lever 150 such that the locked state is adopted. Namely, the banknote pay-out device 101 performs the opposite operation to the shutter opening operation described above, i.e. performs a shutter closing operation by transitioning the shutter 152 from the open state to the closed state and by transitioning the locking lever 150 from the non-locked state to the locked state.

To pay out the banknote bundle W, the banknote pay-out device 101 moves the push-out section 125 toward the pay-out direction, causing the shutter opening-and-closing projection 148 to first abut the locking lever 150 such that the locking lever 150 swings. Thus, the banknote pay-out device 101 moves the swing restriction portion 150S of the locking lever 150 further to the upper side than the abutment portion 152C of the shutter 152, such that the non-locked state is adopted. Moreover, the push-out section 125 is then moved further toward the pay-out direction, causing the shutter opening-and-closing projection 148 to abut the shutter 152 such that the shutter 152 swings, thereby moving the shutter plate 152P further to the upper side than the pay-out port 26 such that the open state is adopted.

In this manner, in order to pay-out the banknote bundle W, the banknote pay-out device 101 is disposed in the open state by moving the swing restriction portion 150S of the locking lever 150 and the shutter plate 152P of the shutter 152 to the upper side.

### 3. Third Exemplary Embodiment

3-1. Configuration of Banknote Pay-out Device and Bundle Conveyance Unit

As illustrated in FIG. 1 and FIG. 2, a banknote pay-out device 201 according to the third exemplary embodiment has the same configuration as the banknote pay-out device 1 according to the first exemplary embodiment except for that a bundle conveyance unit 203 differs from the bundle conveyance unit 3.

3-2. Configuration of Shutter Opening-and-Closing Mechanism

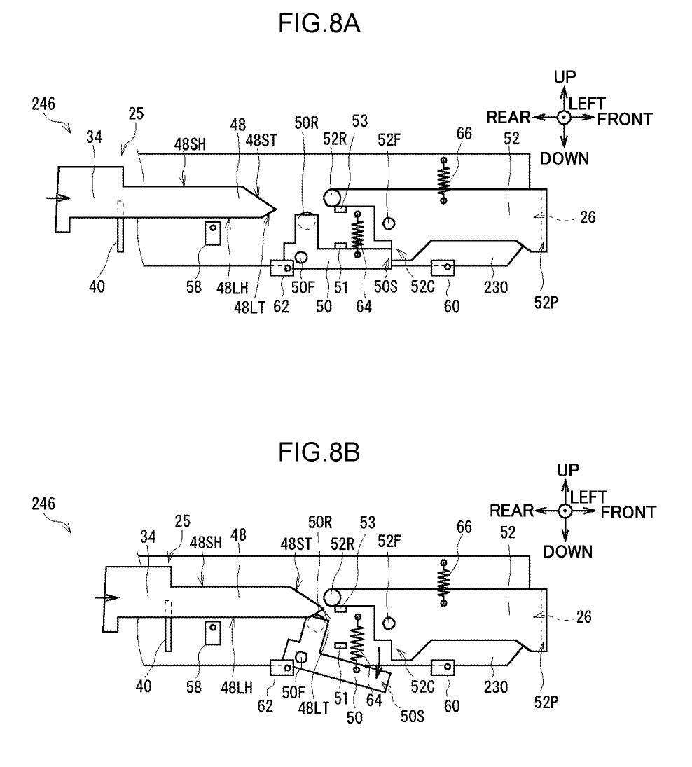

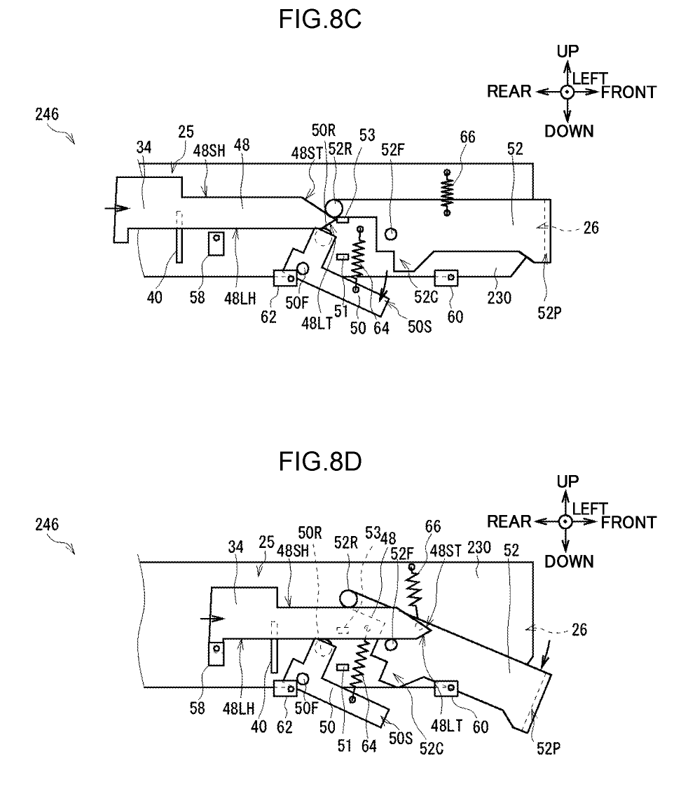

As illustrated in FIG. 8, which corresponds to FIG. 4, a shutter opening-and-closing mechanism 246 according to the third exemplary embodiment is configured the same as the shutter opening-and-closing mechanism 46 according to the first exemplary embodiment except for differing in the point that a locking lever reset spring 64 and a shutter reset spring 66 are provided instead of the reset spring 56.

Due to attaching a lower end of the locking lever reset spring 64, which is a tension spring whose upper end is attached to a bundle conveyance frame 230, in front of the locking lever fulcrum 50F of the locking lever 50, a force is applied to the locking lever 50 that biases the locking lever 50 about the locking lever fulcrum 50F in the locking direction. The locking lever 50 is thus suppressed from swinging any further in the locking direction and positioned at a predetermined swinging position, since in the locked state, the locking lever 50 abuts the locking lever limiter 51 while being biased in the locking direction by the biasing force of the locking lever reset spring 64.

Due to an upper end of the shutter reset spring 66, which is a tension spring whose upper end is attached to a bundle conveyance frame 230, being attached in front of the shutter fulcrum 52F of the shutter 52, a force is applied to the shutter 52 that biases the shutter 52 about the shutter fulcrum 52F in the closing direction. The shutter 52 is thus suppressed from swinging any further in the closing direction and positioned at a predetermined swinging position, since in the closed state, shutter 52 abuts the shutter limiter 53 while being biased in the closing direction by the biasing force of the shutter reset spring 66.

3-3. Operation of Shutter Opening-and-Closing Mechanism

Similar to the banknote pay-out device 1, to pay out a banknote bundle, the banknote pay-out device 201 moves the push-out section 25 in the pay-out direction such that, as illustrated in FIG. 8B, the shutter opening-and-closing projection 48 first abuts the locking lever 50 such that the locking lever 50 swings. Thus, the swing restriction portion 505 of the locking lever 50 moves further toward the lower side than the abutment portion 52C of the shutter 52 such that the non-locked state is adopted. Moreover, the push-out section 25 is then moved further toward the pay-out direction, causing the shutter opening-and-closing projection 48 to abut the shutter 52 as illustrated in FIG. 8C such that the shutter 52 swings, thereby moving the shutter plate 52P further to the lower side than the pay-out port 26 as illustrated in FIG. 8D, such that the open state is adopted.

### 4. Other Exemplary Embodiments

Note that in the first exemplary embodiment described above, explanation was given regarding a case in which the locking lever 50 and the shutter 52 are swung by the shutter opening-and-closing projection 48 integrally formed to the push-out section 25. The present invention is not limited thereto; for example, the locking lever 50 and the shutter 52 may be swung by a shutter opening-and-closing projection that is fixed to the push-out section drive belt 36 separately from the push-out section 25 and that moves accompanying the rotational movement of the push-out section drive belt 36. Namely, to pay out the banknote bundle W, it is sufficient that the locking lever 50 and the shutter 52 be swung by a member that moves together with the push-out section 25 accompanying the rotational movement of the push-out section drive belt 36.

Moreover, the second exemplary embodiment described above may be applied with the locking lever reset spring 64 and the shutter reset spring 66 of the shutter opening-and-closing mechanism 246 according to the third exemplary embodiment instead of the reset spring 156 of the shutter opening-and-closing mechanism 146.

Moreover, in the first exemplary embodiment described above, explanation was given regarding a case in which the present invention is applied to the banknote pay-out device 1, this being a front-facing device in which the pay-out port 26 is provided at the front. The present invention is not limited thereto; the present invention may be applied to a banknote pay-out device that is a rear-facing device in which the front and rear of the bundle conveyance unit 3 are in opposite directions to that of the banknote pay-out device 1, i.e. the stacking hole 16H and the intake hole 17H are attached to the storage unit 2 so as to be respectively aligned with the rear passage hole 20HR and the front passage hole 20HF, and the pay-out port 26 is provided to the rear side. The same applies to the second and third exemplary embodiments.

Moreover, in the exemplary embodiments described above, explanation was given regarding cases in which the push-out plate 40 is plate shaped. The present invention is not limited thereto, and configuration may be made with various shapes capable of conveying the banknote bundle W.

Moreover, in the exemplary embodiments described above, explanation has been given regarding cases in which the present invention is applied to the swinging shutter 52 and the shutter 152. The present invention is not limited thereto, and the present invention may be applied to a shutter that moves back and forth along the up-down direction.

Moreover, in the first exemplary embodiment described above, explanation was given regarding a case in which the present invention is applied to the banknote pay-out device 1 that pays out banknotes. However, the present invention is not limited thereto. For example, the present invention may be applied to various devices that store a paper sheet shaped medium, such as various cash vouchers or securities, or various tickets, and hands over the medium to a user. The same applies to the second and third exemplary embodiments.

Moreover, the present invention is not limited to the respective exemplary embodiments described above and the other exemplary embodiments described above. Namely, the present invention encompasses application to exemplary embodiments appropriately combining some or all elements of the respective exemplary embodiments described above and the other exemplary embodiments described above, and exemplary embodiments deriving from elements thereof.

Moreover, in the first exemplary embodiment described above, explanation was given regarding a case in which the banknote pay-out device 1, serving as a medium handover device, is configured by the pay-out port 26 serving as a handover port, the shutter 52 serving as a shutter, the gripping conveyance guide 22 and the stage 16T serving as a conveyance guide, the push-out plate 40 serving as a conveyance member, and the shutter opening-and-closing projection 48 serving as a shutter opening member. However, the present invention is not limited thereto, and the medium handover device may be configured by handover ports, shutters, conveyance guides, conveyance members, and shutter opening members of various other configurations. The same applies to the second and third exemplary embodiments.

In the first exemplary embodiment described above, explanation was given regarding a case in which the shutter opening-and-closing mechanism 46, serving as the shutter opening-and-closing mechanism, is configured by the push-out plate 40 serving as the conveyance member and the shutter opening-and-closing projection 48 serving as the shutter opening member. However, the present invention is not limited thereto, and the shutter opening-and-closing mechanism may be configured by conveyance members and shutter opening members of various other configurations. The same applies to the second and third exemplary embodiments.

The disclosure of Japanese Patent Application No. 2015-007869 is incorporated in its entirety by reference in the present specification.

All cited documents, patent applications, and technical standards mentioned in the present specification are incorporated by reference in the present specification to the same extent as if the individual cited document, patent application, or technical standard was specifically and individually indicated to be incorporated by reference.

### INDUSTRIAL APPLICABILITY

The present invention may, for example, be applied to a banknote pay-out device that stores banknotes in detachable banknote storage boxes and that pays out banknotes according to user operation.

1. A medium handover device comprising:
a handover port that hands over a medium bundle of a superimposed, paper sheet shaped medium to a user;
a shutter that is provided so as to be capable of closing or opening the handover port;
a conveyance guide that guides the medium bundle;
a conveyance member that is disposed facing the conveyance guide, and that moves in a handover direction toward the handover port while contacting one edge side of the medium bundle to convey the medium bundle toward the handover port; and
a shutter opening member that, as the conveyance member moves toward the handover port, moves together with the conveyance member so as to move the shutter toward an opening direction opening the handover port.

2. The medium handover device of claim 1, further comprising:
a drive source that generates drive force; and
a drive mechanism that is driven by the drive source and that moves the conveyance member and the shutter opening member together.

3. The medium handover device of claim 2, wherein the conveyance member and the shutter opening member are integrally formed together.

4. The medium handover device of claim 1, further comprising:
a locking member that adopts a locked state in which the locking member latches the shutter disposed in a closed state closing the handover port so as to restrict movement of the shutter toward the opening direction, and that adopts a non-locked state separated from the shutter in order to move the shutter from the closed state to an open state opening the handover port; wherein
the shutter opening member moves toward the handover direction and abuts the locking member such that the non-locked state is adopted, after which the shutter opening member moves further toward the handover direction, abuts the shutter, and moves as far as a handover position such that the open state is adopted.

5. The medium handover device of claim 4, wherein the shutter opening member moves from the handover position toward a take-in direction opposite to the handover direction and separates from the shutter such that the closed state is adopted, after which the shutter opening member moves further toward the take-in direction and separates from the locking member such that the locked state is adopted.

6. The medium handover device of claim 4, wherein:
the shutter opening member is formed on the handover port side with a shutter opening member inclined face that is inclined with respect to the handover direction; and
the shutter opening member inclined face abuts the locking member such that the non-locked state is adopted, after which the shutter opening member moves further toward the handover direction such that the shutter opening member inclined face abuts the shutter causing the shutter to move toward the same direction as the locking member such that the open state is adopted.

7. The medium handover device of claim 6, wherein:
the shutter opening member is formed with a shutter opening member horizontal face running along the handover direction further to the opposite side to the handover port than the shutter opening member inclined face;
the shutter opening member inclined face abuts the locking member such that the non-locked state is adopted, after which the shutter opening member horizontal face abuts the locking member so as to retain the non-locked state of the locking member; and
the shutter opening member then moves further toward the handover direction and abuts the shutter such that the shutter is disposed in the open state, after which the shutter opening member horizontal face abuts the shutter so as to retain the open state of the shutter.

8. The medium handover device of claim 7, wherein:
the locking member is provided with a rotatable locking member roller and swings together with the rotatable locking member roller about a predetermined locking member fulcrum point; and
the shutter opening member inclined face is configured by a locking member swinging inclined face that is inclined with respect to the handover direction either upward or downward in an up-down direction orthogonal to both a width direction of the medium bundle and the handover direction and that abuts the locking member roller, and by a shutter-swinging inclined face that is inclined in an opposite direction to the locking member swinging inclined face in the up-down direction and that abuts the shutter.

9. The medium handover device of claim 8, wherein:
the shutter is provided with a rotatable shutter roller and swings together with the rotatable shutter roller about a predetermined shutter fulcrum point; and
the shutter opening member causes the shutter-swinging inclined face to abut the shutter roller and moves toward the handover direction so as to swing the shutter such that the open state is adopted.

10. The medium handover device of claim 4, further comprising:
a shutter detection sensor that detects an open or closed state of the shutter; and
a locking member detection sensor that detects the locked state of the locking member.

11. The medium handover device of claim 1, further comprising:
a storage unit that stores the medium, and that stacks the medium to be handed over to a user so as to generate the medium bundle; and wherein
the conveyance member and the shutter opening member are incorporated into a bundle conveyance unit that is attached to the storage unit and that conveys the medium bundle along the handover direction.

12. The medium handover device of claim 11, wherein the storage unit includes:
a casing incorporated with a conveyance section to convey the medium;
a medium storage box that stores the medium, and that is detachable with respect to the casing from a predetermined side face of the casing;
a stacking section that stacks the medium that has been fed out from the medium storage box and conveyed by the conveyance section, and that conveys the medium toward the bundle conveyance unit; and
a reject storage box that stores the medium bundles received from the bundle conveyance unit.

13. A shutter opening-and-closing mechanism comprising:
a conveyance member that moves in a handover direction toward a handover port where a medium bundle of a superimposed, paper sheet shaped medium is handed over to a user while the conveyance member contacts one edge side of the medium bundle to convey the medium bundle toward the handover port; and
a shutter opening member that, as the conveyance member moves toward the handover port, moves together with the conveyance member and moves a shutter provided so as to be capable of closing or opening the handover port toward an opening direction to open the handover port.
